(19) United States
(12) Patent Application Publication
(10) Pub. No.: US 2010/0207057 A1
(43) Pub. Date: Aug. 19, 2010

(54) POLISHING COMPOSITION

(76) Inventors: Hiroshi Nitta, Kyoto (JP); Yoshiyuki Matsumura, Kyoto (JP)

Correspondence Address: HARNESS, DICKEY & PIERCE, P.L.C., P.O. BOX 8910, RESTON, VA, 20195, US

(21) Appl. No.: 12/733,309

(22) PCT Filed: Aug. 25, 2008
(86) PCT No.: PCT/JP2008/065130

§ 371 Date: Feb. 23, 2010

(30) Foreign Application Priority Data
Aug. 23, 2007 (JP) 2007-217672

(51) Int. Cl. C09K 13/00

(52) U.S. Cl. 252/79.1

(57) ABSTRACT

An object of one embodiment of the present invention is to provide a polishing composition which suppresses generation of recessing and dishing and includes a higher polishing rate. The polishing composition of an embodiment of the invention is a polishing composition suitable for a metal film, particularly a copper (CU) film, and contains ammonia, hydrogen peroxide, an amino acid and an anionic surfactant, the remainder being water. By containing those, the polishing composition can suppress generation of recessing and dishing when particularly used in the second step polishing.

### TECHNICAL FIELD

The present invention relates to a polishing composition for polishing a metal film, in particular, for polishing a copper film.

### BACKGROUND ART

To meet demands for high integration and reduction in size of semiconductor integrated circuits (LSIs), a technique called system in package (SIP) in which a plurality of semiconductors having various functions such as memory function and logic function are three-dimensionally mounted on one substrate has been developed. With this technique, numbers of wirings and bumps, formed on the substrate are increased, and diameters of wirings are decreased. As a result, formation of fine wirings becomes difficult in conventional build-up methods and mechanical polishing.

For this reason, copper, copper alloy and the like having electric resistance lower than that of aluminum are utilized in place of aluminum conventionally used as a wiring material. However, due to the properties of copper, copper is difficult to form wiring by dry etching as in aluminum, and for this reason, a wiring formation method called a damascene process is established.

According to a damascene process used in a semiconductor process, for example, wirings and plugs are formed on the surface of a substrate by forming grooves corresponding to wiring patterns to be formed and holes corresponding to plugs (electrically connecting portions to wirings in the inside of a substrate) to be formed on the surface of a substrate coated with a silicon dioxide film, forming a barrier metal film (insulating film) comprising titanium, titanium nitride, tantalum, tantalum nitride, tungsten or the like on an inner wall surface of the grooves and holes, coating the whole surface of the substrate with a copper film by plating or the like to embed copper in the grooves and holes, and removing excess copper film on a region other than the grooves and holes by chemical mechanical polishing (CMP).

The damascene process and CMP can be applied to SIP in a similar manner. However, because a thickness of a metal film such as a copper film coated on the surface of a substrate ranges 5 μm or more, there are concerns regarding increase in processing time by CMP and great deterioration of productivity.

It is considered in CMP to a metal layer that polishing proceeds by a process that compounds formed on the surface of a metal by chemical reaction in an acidic region are polished by polishing abrasive grains. From this, slurry used in CMP to a metal layer is generally acidic (see Japanese Unexamined Patent Publication JP-A 2002-270545).

However, acidic slurry has the tendency that polishing rate is decreased as the number of layers to be polished is increased. Furthermore, when an alkaline washing liquid for removing abrasive grains is used after polishing, abrasive grains become massed together by pH shock. For this reason, alkaline slurry enabling high speed polishing is desired in place of acidic slurry.

As described in JP-A 2002-270545, a polishing composition containing a compound having at least three azole groups in the molecule, an oxidizing agent, and at least one selected from an amino acid, an organic acid and an inorganic acid is investigated as the alkaline slurry. Furthermore, ozone, hydrogen peroxide, periodate and the like are used as the oxidizing agent, and anionic, cationic, nonionic and amphoteric surfactants are used as the surfactant.

A protective film is formed by the compound having at least three azole groups in the molecule, and this permits control of polishing rate of a barrier metal, thereby suppressing erosion.

An object of the invention is to provide a polishing composition which suppresses generation of recessing and dishing and has higher polishing rate.

The invention provides a polishing composition comprising ammonia, hydrogen peroxide, an amino acid and alkyl benzene sulfonate.

In the invention, it is preferable that the polishing composition has a pH of 7 to 11.5.

In the invention, it is preferable that the amino acid is a neutral amino acid.

In the invention, it is preferable that the neutral amino acid is at least one selected from glycine, alanine, valine, leucine, isoleucine, proline and triptophan.

### DISCLOSURE OF INVENTION

In general, a metal layer is polished with a plurality of steps. In a first step polishing, the polishing composition used is required to achieve high polishing rate for the reason that the first step polishing has a main object to reduce only a thickness of the metal layer. In a second step polishing, the metal layer having a reduced thickness is completely removed, and wirings and plugs are formed.

To completely remove the metal layer, overpolishing which thinly polishes up to an insulating layer is required. In the conventional polishing composition, recessing and dishing are generated in conducting overpolishing. Furthermore, the conventional polishing composition does not have load dependency and has low polishing rate. Therefore, the conventional polishing composition requires much time for polishing.

### BRIEF DESCRIPTION OF DRAWINGS

Other and further objects, features, and advantages of the invention will be more explicit from the following detailed description taken with reference to the drawings wherein:

FIG. 1 is a graph showing measurement results of polishing rate under low load condition (27 hPa) and polishing rate under high load condition (140 hPa);

FIG. 2 is a graph showing influence on polishing rate by an amino acid content;

FIG. 3 is a graph showing influence on polishing rate by an ammonia content;

FIG. 4 is a graph showing influence of pH on polishing rate;

FIG. 5 is a graph showing influence on load dependency by the presence or absence of abrasive grains;

FIG. 6 is a graph showing influence on load dependency by the content of abrasive grains;

FIG. 7 is a graph showing the measurement result of dishing amount; and

FIG. 8 is a graph showing measurement results of polishing rate under each load condition.

### BEST MODE FOR CARRYING OUT THE INVENTION

Now referring to the drawings, preferred embodiments of the invention are described below.

The polishing composition of the invention is a polishing composition suitable for a metal film, particularly a copper (Cu) film, and contains ammonia, hydrogen peroxide, an amino acid and an anionic surfactant, the remainder being water. By containing those, the polishing composition can suppress generation of recessing and dishing when particularly used in the second step polishing, and can achieve higher polishing rate.

In particular, because the polishing composition has load dependency that polishing rate under low load is low and polishing rate under high load is higher, the polishing composition exhibits excellent level-difference elimination property in a wiring part of a wafer which is a material to be polished.

The polishing composition of the invention is described in detail below.

In an alkaline region, ammonia (NH₃) acts as a complexing agent and an oxidizing agent to Cu, and reacts with Cu to form a complex as shown in the formula (1).

Cu+4NH₄⁺→[Cu(NH₃)₄]²⁺ (1)

In CMP of a copper film, it is considered that the tetraammine copper complex is removed by contacting with a polishing pad, and polishing is accelerated.

The content of ammonia in the polishing composition of the invention is from 0.3 to 9% by weight, and preferably from 1 to 5% by weight, of the total amount of the polishing composition. Where the content of ammonia is less than 0.3% by weight, sufficient polishing rate is not obtained, and where the content exceeds 9% by weight, polishing rate under low load is increased, and level-difference elimination properties are decreased.

Furthermore, according to the invention, by containing hydrogen peroxide, the hydrogen peroxide functions as an oxidizing agent, higher polishing rate is realized, and uniformity is greatly improved. This is because by adding hydrogen peroxide, the polishing rate does not depend on flow rate of the polishing composition, and even though local scattering in flow rate of the polishing composition is generated on the surface of a material to be polished, the entire material to be polished is uniformly polished.

The content of hydrogen peroxide in the polishing composition of the invention is from 0.05 to 5.0% by weight, and preferably from 0.1 to 4.0% by weight, of the total amount of the polishing composition. Where the content of hydrogen peroxide is less than 0.05% by weight, sufficient polishing rate is not obtained, and where the content exceeds 5.0% by weight, etching rate of a material to be polished is too high, which is not preferred.

By further containing an amino acid, the invention exhibits excellent load dependency and realizes higher polishing rate than the conventional polishing rate.

By the amino acid, a brittle reaction film is formed on the surface of a material to be polished, and simultaneously etching force to the surface of a material to be polished is suppressed. Therefore, the surface of a material to be polished, contacting with a polishing pad is removed, but the bottom of a recessed part of an embedded portion which does not contact with a polishing pad is not removed. Thus, excellent load dependency is exhibited and level-difference elimination properties are improved.

Even though any amino acid is used as the amino acid contained in the polishing composition of the invention, the same effect is exhibited. From the standpoint of suppression of dishing, a neutral amino acid is preferably used. According to, for example, a literature reference (McMurry, Fundamentals of Organic Chemistry, second edition, translated by Itoh and Kodama, Tokyo Kagaku Dojin, Nov. 24, 1992, p. 463-467), the amino acid has a structure represented by the general formula (2) wherein R indicates a side chain. The amino acid is classified into a neutral amino acid, a basic amino acid and an acidic amino acid depending on properties of a side chain. An amino acid having a neutral side chain is a neutral amino acid, an amino acid having an acidic side chain is an acidic amino acid, and an amino acid having a basic side chain is a basic amino acid.

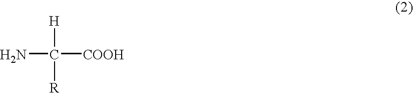

The neutral amino acid has a neutral side chain, and many neutral amino acids contain a functional group having electron donating property. By the electron donating property of a side chain, activity of a carboxyl group is increased, and the carboxyl group coordinates on the surface of a metal which is a material to be polished, thereby forming a strong reaction film which is not eliminated under a polishing pressure of 27 hPa or less. The neutral amino acid coordinates on the surface of a metal such that the neutral side chain exposes. Furthermore, electron cloud is formed on the surface of a metal by the mutually adjacent neutral side chains. The electron cloud disturbs movement of ammonium ion to the surface of a metal, thereby suppressing the surface of a metal from etching.

Thus, by using the neutral amino acid, film formation by a functional group having low reactivity (methyl group, ethyl group, cyclic phenyl group, cyclic indole group, and the like) is conducted to the surface of a material to be polished, etching force to the surface of a material to be polished is further suppressed, and dishing can be suppressed. As the functional group having electron donating property, methyl group, ethyl group and its existent number, or cyclic groups such as phenyl group and indole group are preferred.

Use of the amino acid can suppress polishing rate under low load, and improve polishing rate under high load. Of the neutral amino acids, when at least one selected from glycine, alanine, valine, leucine, isoleucine, proline and triptophan, having the above functional group is used, low load region which suppresses polishing rate low can be expanded. This can exhibit excellent load dependency that polishing rate is sufficiently suppressed low in a low load region until exceeding a given load (for example 39 hPa), and when exceeding the given load, polishing rate is rapidly increased.

Particularly, triptophan having an indole ring has electron donating property, and further has the function that an amide bond present in the indole ring captures ammonia and amines present in the polishing composition. For this reason, the triptophan can suppress etching capability to the surface of a material to be polished, by ammonia and amines. Therefore, of the neutral amino acids, the triptophan is particularly preferred.

The content of the amino acid in the polishing composition of the invention is from 0.1 to 10% by weight of the total amount of the polishing composition. Where the content of the amino acid is less than 0.1% by weight and exceeds 10% by weight, polishing rate under low load is increased, and level-difference elimination properties are decreased.

Furthermore, when alkyl benzene sulfonate is present in a polishing composition, alkyl benzene sulfonate coordinates so as to surround around the tetraammine copper complex, and a kind of a protective film is formed.

Etching of copper is suppressed by the protective film, and suppression of dishing or the like and improvement in level-difference elimination properties are realized. Furthermore, the protective film is difficult to be removed by polishing under low load, and suppresses polishing rate under low load. On the other hand, the protective film is easily removed when load is increased, and polishing acceleration effect by the tetrammine copper complex is exhibited.

As alkyl benzene sulfonate contained in the polishing composition of the invention, dodecylbenzene sulfonate is preferred.

The content of alkyl benzene sulfonate in the polishing composition of the invention is from 0.01 to 3.0% by weight, and preferably from 0.05 to 2.0% by weight, of the total amount of the polishing composition. Where the content of alkyl benzene sulfonate is less than 0.01% by weight, polishing rate under low load is increased, thereby decreasing level-difference elimination properties, and where the content exceeds 3.0% by weight, sufficient polishing rate is not obtained.

The invention can physically scrape off a reaction layer and a protective layer, formed on the surface layer of a material to be polished, by containing abrasive grains. As a result, polishing rate is improved particularly under high load condition.

As the abrasive grains, materials conventionally used in this field can be used, and examples thereof include colloidal silica, fumed silica, colloidal alumina, fumed alumina and ceria.

Level-difference elimination properties based on load dependency are exhibited regardless of the content of abrasive grains. Therefore, the content of the abrasive grains in the polishing composition of the invention is not particularly limited so long as the content does not have the problem on practical use.

In the polishing composition of the invention, its pH is neutral or alkaline, and is specifically from 7 to 11.5. The acidic case is not preferred as described before, and where the pH exceeds 11.5, polishing rate under high load condition is too low, which is not preferred.

The polishing composition of the invention may further contain a nonionic surfactant, a pH regulator and the like in addition to the above components.

The nonionic surfactant includes fatty acid monoethanol amide, fatty acid diethanol amide, fatty acid ethylene glycol ester, monofatty acid glycerin ester, fatty acid sorbitan ester, fatty acid sucrose ester, alkyl polyoxyethylene ether, polyvinyl pyrrolidone, polyvinyl alcohol, hydroxyethyl cellulose, carboxymethyl cellulose, polyethylene glycol, polyoxyethylene lauryl ether and polyoxyethylene oleyl ether. Of those, carboxymethyl cellulose is preferred.

As to the pH regulator, examples of an acidic component include nitric acid (HNO₃), sulfuric acid, hydrochloric acid, acetic acid and lactic acid, and examples of an alkaline component include potassium hydroxide (KOH), calcium hydroxide and lithium hydroxide.

The polishing composition of the invention can contain one or two or more of various additives conventionally used in the polishing composition in this field so long as the preferred characteristics thereof are not impaired.

Water used in the polishing composition of the invention is not particularly limited. However, considering use in a production step of, for example, a semiconductor device, pure water, ultrapure water, ion-exchanged water, distilled water, and the like are preferred.

In the second step polishing, the metal layer on the insulating layer is completely removed as above by contacting with a polishing pad. In this case, the surface of metal in a wiring part is removed by etching. When polishing is advanced to conduct overpolishing, load is applied to the insulating layer by contacting with a polishing pad, and polishing proceeds by an alkaline polishing composition. However, load to the wiring part removed by etching is decreased. Therefore, in the polishing composition of the invention having load independency, polishing rate in the wiring part is greatly decreased. This can suppress recessing and dishing from generating, and uniform polished surface is obtained.

Method for producing the polishing composition of the invention is described below.

In the case where the polishing composition does not contain abrasive grains and is composed of ammonia, hydrogen peroxide, an amino acid and alkyl benzene sulfonate, those compounds are used in appropriate amounts, and water is used in an amount to make the total amount 100% by weight. The polishing composition can be produced by uniformly dissolving or dispersing those components in water so as to become the desired pH according to the general procedures.

In the case that the polishing composition contains abrasive grains, alkyl benzene sulfonate is first mixed with water, and a given amount of an ammonia aqueous solution having a concentration of 30% is mixed therewith, and thereafter an amino acid is added, thereby obtaining an alkali solution. A silica dispersion having a pH adjusted to 4.0 to 6.0 is mixed with the alkali solution so as to achieve a given concentration. A given amount of hydrogen peroxide solution having a concentration of 30% was mixed with the alkali solution containing silica. Thus, a polishing composition of the invention is obtained.

The polishing composition of the invention can preferably be used in polishing of various metal films in LSI production process, and can, in particular, preferably used as a polishing slurry for polishing a metal film in CMP process in forming metal wiring by a damascene process. More specifically, the polishing composition of the invention can highly preferably be used as a metal film polishing slurry in forming, for example, metal wiring for stacking LSI chip in SIP, and upper layer copper wiring of semiconductor device (for the formation of the copper wiring, it is necessary to polish a copper film having a film thickness of 5 μm or more). In other words, the polishing composition of the invention is particularly useful as a metal film polishing composition for CMP process by a damascene process.

Examples of the metal film to be polished here include metal films such as copper and copper alloy to be coated on the surface of a substrate, tantalum, tantalum nitride, titanium, titanium nitride, and tungsten. Among them, a metal film of copper is particularly preferred.

### EXAMPLES

Examples of the invention are described below.

Examples of the invention were prepared with the following compositions.

### Example 1

| | |
|---|---|
| Ammonia | 2% by weight |
| Hydrogen peroxide | 0.5% by weight |
| Amino acid: glycine | 1% by weight |
| Dodecylbenzene sulfonic acid | 0.5% by weight |
| Abrasive grains: colloidal silica | 2% by weight |
| Water | Remainder |

### Example 2

| | |
|---|---|
| Ammonia | 2% by weight |
| Hydrogen peroxide | 0.5% by weight |
| Amino acid: alanine | 1% by weight |
| Dodecylbenzene sulfonic acid | 0.5% by weight |
| Abrasive grains: colloidal silica | 2% by weight |
| Water | Remainder |

### Example 3

| | |
|---|---|
| Ammonia | 2% by weight |
| Hydrogen peroxide | 0.5% by weight |
| Amino acid: cerine | 1% by weight |
| Dodecylbenzene sulfonic acid | 0.5% by weight |
| Abrasive grains: colloidal silica | 2% by weight |
| Water | Remainder |

### Example 4

| | |
|---|---|
| Ammonia | 2% by weight |
| Hydrogen peroxide | 0.5% by weight |
| Amino acid: threonine | 1% by weight |
| Dodecylbenzene sulfonic acid | 0.5% by weight |
| Abrasive grains: colloidal silica | 2% by weight |
| Water | Remainder |

### Example 5

| | |
|---|---|
| Ammonia | 2% by weight |
| Hydrogen peroxide | 0.5% by weight |
| Amino acid: cysteine | 1% by weight |
| Dodecylbenzene sulfonic acid | 0.5% by weight |
| Abrasive grains: colloidal silica | 2% by weight |
| Water | Remainder |

### Example 6

| | |
|---|---|
| Ammonia | 2% by weight |
| Hydrogen peroxide | 0.5% by weight |
| Amino acid: methionine | 1% by weight |
| Dodecylbenzene sulfonic acid | 0.5% by weight |
| Abrasive grains: colloidal silica | 2% by weight |
| Water | Remainder |

### Example 7

| | |
|---|---|
| Ammonia | 2% by weight |
| Hydrogen peroxide | 0.5% by weight |
| Amino acid: valine | 1% by weight |
| Dodecylbenzene sulfonic acid | 0.5% by weight |
| Abrasive grains: colloidal silica | 2% by weight |
| Water | Remainder |

### Example 8

| | |
|---|---|
| Ammonia | 2% by weight |
| Hydrogen peroxide | 0.5% by weight |
| Amino acid: leucine | 1% by weight |
| Dodecylbenzene sulfonic acid | 0.5% by weight |
| Abrasive grains: colloidal silica | 2% by weight |
| Water | Remainder |

### Example 9

| | |
|---|---|
| Ammonia | 2% by weight |
| Hydrogen peroxide | 0.5% by weight |
| Amino acid: aspartic acid | 1% by weight |
| Dodecylbenzene sulfonic acid | 0.5% by weight |
| Abrasive grains: colloidal silica | 2% by weight |
| Water | Remainder |

### Example 10

| | |
|---|---|
| Ammonia | 2% by weight |
| Hydrogen peroxide | 0.5% by weight |
| Amino acid: histidine | 1% by weight |
| Dodecylbenzene sulfonic acid | 0.5% by weight |
| Abrasive grains: colloidal silica | 2% by weight |
| Water | Remainder |

### Example 11

| | |
|---|---|
| Ammonia | 2% by weight |
| Hydrogen peroxide | 0.5% by weight |
| Amino acid: triptophan | 1% by weight |
| Dodecylbenzene sulfonic acid | 0.5% by weight |
| Abrasive grains: colloidal silica | 2% by weight |
| Water | Remainder |

### Example 12

| | |
|---|---|
| Ammonia | 2% by weight |
| Hydrogen peroxide | 0.5% by weight |
| Amino acid: proline | 1% by weight |
| Dodecylbenzene sulfonic acid | 0.5% by weight |
| Abrasive grains: colloidal silica | 2% by weight |
| Water | Remainder |

### Example 13

| | |
|---|---|
| Ammonia | 1.5% by weight |
| Hydrogen peroxide | 0.5% by weight |
| Amino acid: isoleucine | 1% by weight |
| Dodecylbenzene sulfonic acid | 0.5% by weight |
| Abrasive grains: colloidal silica | 0.5% by weight |
| Water | Remainder |

### Comparative Example 1

| | |
|---|---|
| Ammonia | 2% by weight |
| Hydrogen peroxide | 0.5% by weight |
| Dodecylbenzene sulfonic acid | 0.5% by weight |
| Abrasive grains: colloidal silica | 2% by weight |
| Water | Remainder |

### Comparative Example 2

| | |
|---|---|
| Ammonia | 2% by weight |
| Hydrogen peroxide | 0.5% by weight |
| Adenine | 1% by weight |
| Dodecylbenzene sulfonic acid | 0.5% by weight |
| Abrasive grains: colloidal silica | 2% by weight |
| Water | Remainder |

In Examples 1 to 12 and the Comparative Examples, pH was adjusted to 9.5.

In Example 13, pH was adjusted to 10.5.

Examples 1 to 13 are that the kind of the amino acid added was changed, respectively. Comparative Example 1 is the same as the Examples, except that an amino acid is not contained, and Comparative Example 2 is the same as the Examples, except for containing adenine in place of an amino acid.

### [Evaluation of Load Dependency]

Using those Examples and Comparative Examples, polishing rates under low load and high load were measured, and load dependency was evaluated.

Polishing conditions and evaluation method of polishing rate are as follows.

Polishing Conditions

Substrate to be polished: 100 mm diameter copper-plated substrate

Polishing apparatus: ECOMET 4 (manufactured by BUEHLER)

Polishing pad: IC 1400 (manufactured by Nitta Haas Incorporated)

Relative speed of polishing platen: 745 mm/sec

Polishing load surface pressure: 27 hPa, 140 hPa

Flow rate of polishing composition: 30 ml/min

Polishing time: 60 seconds

Polishing Rate

The polishing rate is represented by a thickness (μm/min) of a substrate removed by polishing per unit time. The thickness of a substrate removed by polishing was calculated by measuring weight loss of the weight of a substrate and dividing the weight loss by an area of polished surface of a substrate.

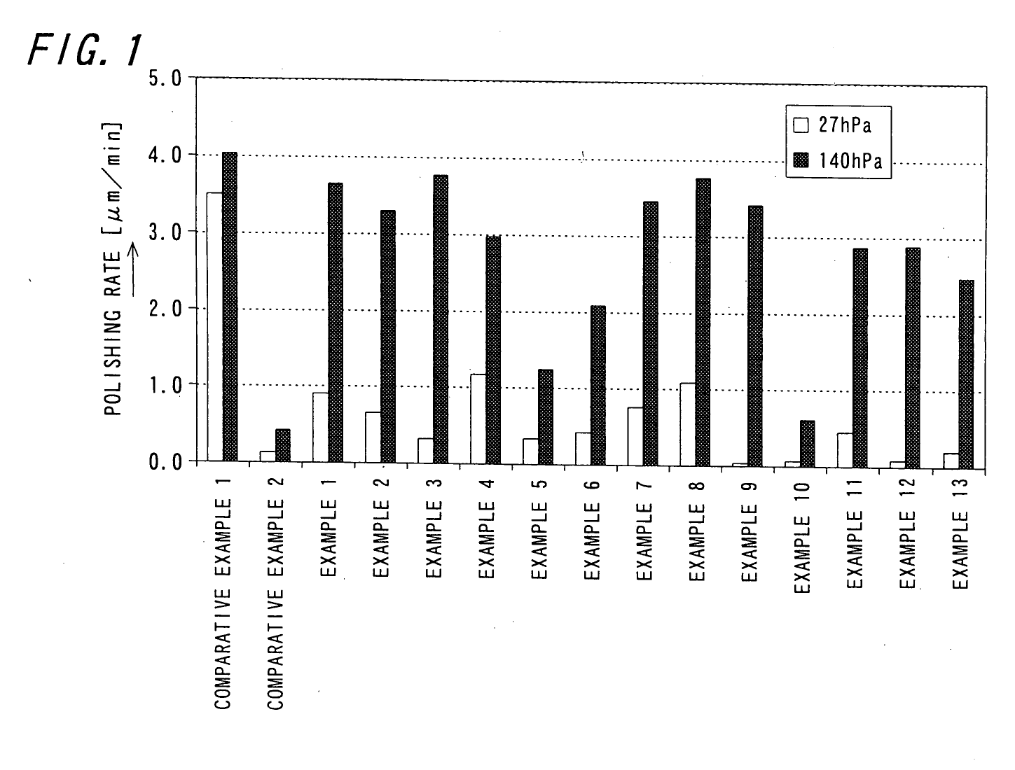

Measurement results of polishing rate under low load condition (27 hPa) and polishing rate under high load condition (140 hPa) are shown in Table 1 and FIG. 1.

TABLE 1

| | Load | Polishing rate |
|---|---|---|
| | [hPa] | [μm/min] |
| Example 1 | 27 | 0.90 |
| | 140 | 3.64 |
| Example 2 | 27 | 0.65 |
| | 140 | 3.30 |
| Example 3 | 27 | 0.32 |
| | 140 | 3.75 |
| Example 4 | 27 | 1.16 |
| | 140 | 2.98 |
| Example 5 | 27 | 0.34 |
| | 140 | 1.23 |
| Example 6 | 27 | 0.42 |
| | 140 | 2.08 |
| Example 7 | 27 | 0.76 |
| | 140 | 3.45 |
| Example 8 | 27 | 1.08 |
| | 140 | 3.75 |
| Example 9 | 27 | 0.05 |
| | 140 | 3.41 |
| Example 10 | 27 | 0.07 |
| | 140 | 0.62 |
| Example 11 | 27 | 0.45 |
| | 140 | 2.88 |
| Example 12 | 27 | 0.08 |
| | 140 | 2.89 |
| Example 13 | 27 | 0.20 |
| | 140 | 2.60 |
| Comparative | 27 | 3.5 |
| Example 1 | 140 | 4.02 |
| Comparative | 27 | 0.13 |
| Example 2 | 140 | 0.42 |

Comparative Example 1 does not contain an amino acid. As a result, polishing rate under low load condition could not be suppressed low, and load dependency was not seen. In Comparative Example 2, load dependency was slightly seen, but polishing rate under high load condition was not sufficient.

Regarding Examples 1 to 13 containing an amino acid, load dependency was clearly seen, and high polishing rate under high load condition could be realized.

### [Investigation of Amino Acid Content]

Based on the composition of Example 9 containing aspartic acid as an amino acid, polishing rates under low load (7 hPa) and high load (140 hPa) when the amino acid content was changed from 0 to 25% by weight were measured.

The polishing conditions and the evaluation method of polishing rate are the same as above.

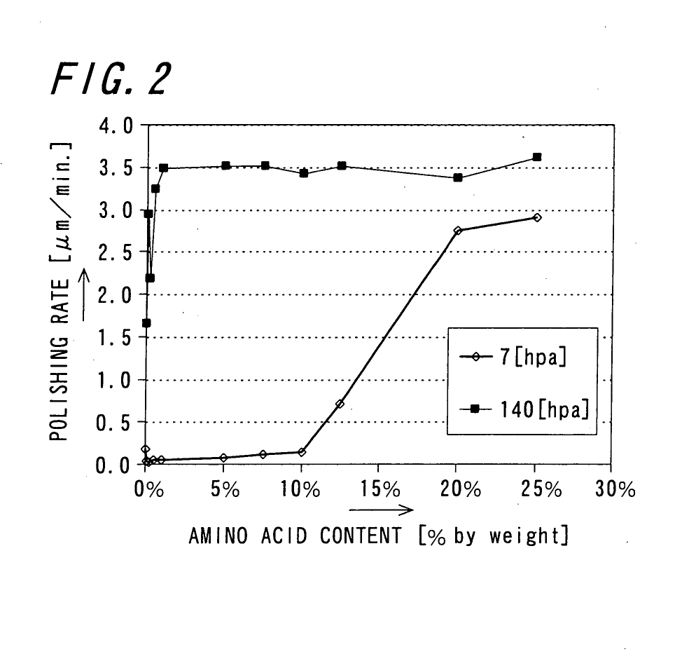

FIG. 2 is a graph showing influence on polishing rate by an amino acid content.

The horizontal axis indicates an amino acid content [% by weight], and the vertical axis indicates polishing rate [μm/min].

As is seen from the graph, when the content is 0 and 12.5% by weight or more, polishing rate under low load condition (7 hPa) is increased. From this fact, the range of application of the amino acid content is from 0.10 to 10% by weight.

### [Investigation of Ammonia Content]

Based on the composition of Example 9 containing aspartic acid as an amino acid, polishing rates under low load (7 hPa) and high load (140 hPa) when the ammonia content was changed from 0 to 15% by weight were measured.

The polishing conditions and the evaluation method of polishing rate are the same as above.

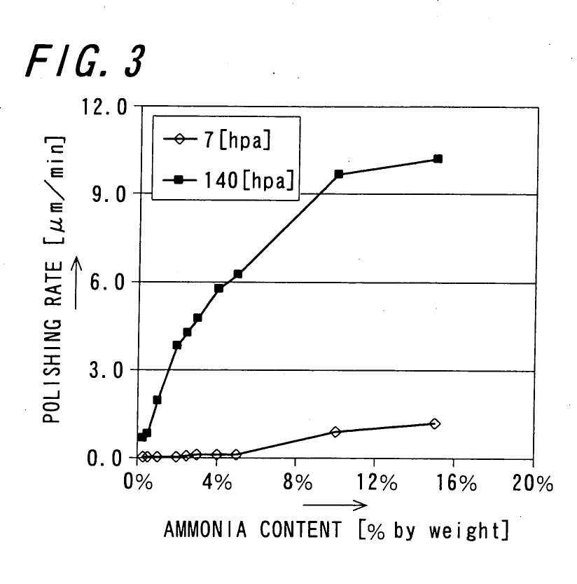

FIG. 3 is a graph showing influence on polishing rate by an ammonia content.

The horizontal axis indicates an ammonia content [% by weight], and the vertical axis indicates polishing rate [μm/min].

As is seen from the graph, when the content is 10% by weight or more, polishing rate under low load condition (7 hPa) is increased, and when ammonia is not contained (the content is 0% by weight), polishing rates under low load and high load are 0. From this fact, the range of application of the ammonia content is from 0.30 to 9% by weight. Furthermore, it says that 1 to 5% by weight is a preferred range from the fact that higher polishing rate is realized.

[Investigation of pH]

Based on the composition of Example 9 containing aspartic acid as an amino acid, polishing rates under low load (7 hPa) and high load (140 hPa) were measured at a pH of from 6.5 to 12.

The polishing conditions and the evaluation method of polishing rate are the same as above.

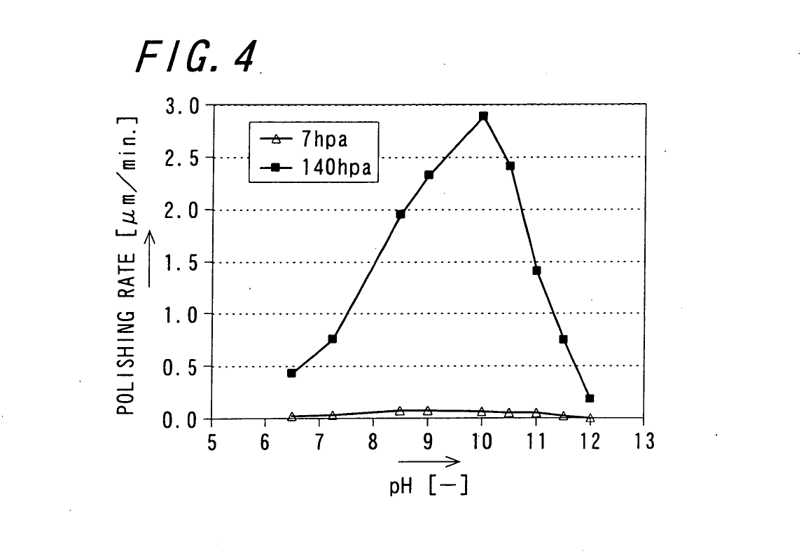

FIG. 4 is a graph showing influence of pH on polishing rate.

The horizontal axis indicates pH [-], and the vertical axis indicates polishing rate [μm/min].

As is seen from the graph, when pH is 6.5 and 12, polishing rate under high load condition (140 hPa) is too low. From this fact, the range of pH examined is from 7 to 11.5.

### [Investigation of Presence or Absence of Abrasive Grain and Abrasive Grain Content]

Based on the composition of Example 9 containing aspartic acid as an amino acid, influence on load dependency by the presence or absence of abrasive grains at a pH of 9.75 was investigated.

The polishing conditions and the evaluation method of polishing rate are the same as above.

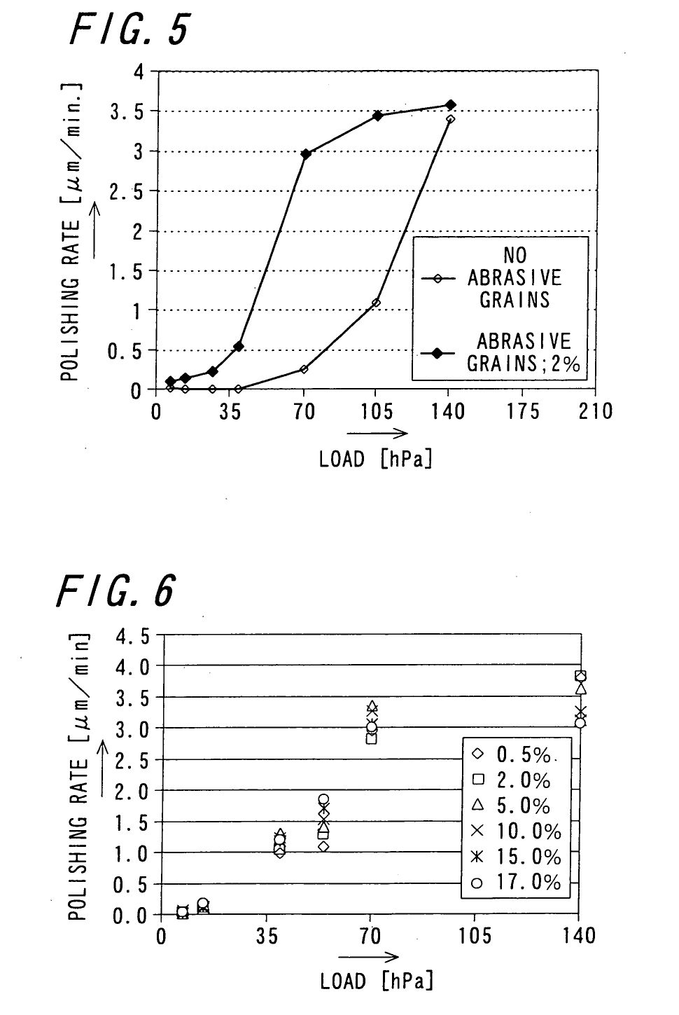

FIG. 5 is a graph showing influence on load dependency by the presence or absence of abrasive grains.

The horizontal axis indicates load [hPa], and the vertical axis indicates polishing rate [μm/min].

As is seen from the graph, under the condition that load is 7 hPa and 140 hPa, polishing rate is the same regardless of the presence or absence of abrasive grains, and load dependency is seen.

In the case that abrasive grains are contained, increase in polishing rate was seen at lower load side, and in the case that abrasive grains are not contained, increase in polishing rate was seen at higher load side.

Regarding the content of abrasive grains, based on the composition of Example 9, influence on load dependency when the content was changed from 0.5 to 17% by weight was investigated.

The polishing conditions and the evaluation method of polishing rate are the same as above.

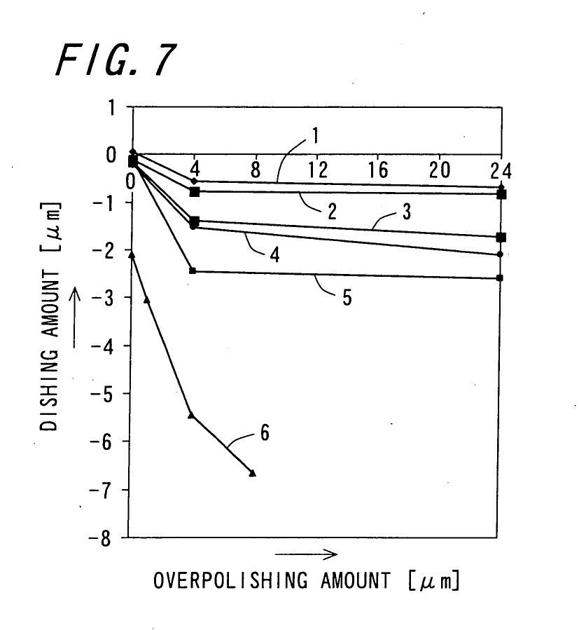

FIG. 6 is a graph showing influence on load dependency by the content of abrasive grains.

The horizontal axis indicates load [hPa], and the vertical axis indicates polishing rate [μm/min].

As is seen from the graph, the same load dependency was seen, regardless of the content of abrasive grains.

### [Evaluation of Dishing]

To conduct evaluation of dishing, Examples 14 to 18 and Comparative Example 3 were prepared with the following compositions.

### Example 14

| | |
|---|---|
| Ammonia | 1.5% by weight |
| Hydrogen peroxide | 0.5% by weight |
| Amino acid: triptophan | 1.0% by weight |
| Dodecylbenzene sulfonic acid | 0.5% by weight |
| Abrasive grains: colloidal silica | 0.5% by weight |
| Water | Remainder |

### Example 15

Example 15 was obtained in the same manner as in Example 14, except for using proline in place of triptophan as an amino acid.

### Example 16

Example 16 was obtained in the same manner as in Example 14, except for using alanine in place of triptophan as an amino acid.

### Example 17

Example 17 was obtained in the same manner as in Example 14, except for using glycine in place of triptophan as an amino acid.

### Example 18

Example 18 was obtained in the same manner as in Example 14, except for using aspartic acid in place of triptophan as an amino acid.

### Comparative Example 3

Comparative Example 3 was obtained in the same manner as in Example 14, except for using maleic acid in place of an amino acid.

In Examples 14 to 18 and Comparative Example 3, pH was adjusted to 10.5.

Polishing conditions and evaluation method of dishing are as follows.

### Polishing Conditions

Substrate to be polished: 100 mm diameter copper-plated substrate

Polishing apparatus: ECOMET 4 (manufactured by BUEHLER)

Polishing pad: IC 1400 (manufactured by Nitta Haas Incorporated)

Relative speed of polishing platen: 1,000 mm/sec

Polishing load surface pressure: 140 hPa

Flow rate of polishing composition: 30 ml/min

Dishing Amount

A substrate having provided thereon copper wiring having a wiring width of 200 μm, a wiring distance of 200 μm and a depth of 10 μm and having a copper plate film having a thickness of 10 μm formed on the entire surface was used as a 100 mm diameter copper-plated substrate which is a substrate to be polished. After the copper-plated substrate was polished to expose the copper wiring, overpolishing was conducted and the amount of dishing was measured.

The amount of a thickness of the copper film which will be polished when additional polishing is conducted after exposing the wiring is used as an overpolishing amount. Based on the polishing rate up to exposure of the wiring, polishing time corresponding to the overpolishing amount is set every Example and Comparative Example, and additional polishing was conducted.

After completion of the additional polishing, depth of recess formed on the surface of copper wiring was measured with a measurement instrument (trade name: SURFCOM 1400D, manufactured by Tokyo Seimitsu Co., Ltd.), and the measurement result was used as dishing amount.

FIG. 7 is a graph showing the measurement result of dishing amount.

The horizontal axis indicates overpolishing amount [μm], and the vertical axis indicates dishing amount [μm].

Graph 1 shows Example 14 (containing triptophan), graph 2 shows Example 15 (containing proline), graph 3 shown Example 16 (containing alanine), graph 4 shows Example 17 (containing glycine), graph 5 shows Example 18 (containing aspartic acid), and graph 6 shows Comparative Example 3 (containing maleic acid).

As is seen from the graphs, in Comparative Example 3, dishing amount was large, and dishing amount was increased with increasing overpolishing amount.

Contrary to this, in Examples 14 to 18, although dishing is generated at the beginning of additional polishing, the dishing amount is small, and was suppressed to nearly a constant dishing amount even though overpolishing amount was increased.

Furthermore, it was found that the dishing amount of Examples 14 to 17 containing a neutral amino acid is smaller than the dishing amount of Example 18 containing an acidic amino acid, and a neutral amino acid can suppress the generation of dishing as compared with an acidic amino acid.

### [Load Dependency of Neutral Amino Acid]

Further detailed load dependency was evaluated for a neutral amino acid having excellent dishing properties.

To conduct evaluation of load dependency, Examples 19 to 28 were prepared with the following compositions.

### Example 19

| | |
|---|---|
| Ammonia | 1.5% by weight |
| Hydrogen peroxide | 0.5% by weight |
| Amino acid: glycine | 2.0% by weight |
| Dodecylbenzene sulfonic acid | 0.5% by weight |
| Abrasive grains: colloidal silica | 0.5% by weight |
| Water | Remainder |

### Example 20

Example 20 was obtained in the same manner as in Example 19, except for using alanine in place of glycine as an amino acid.

### Example 21

Example 21 was obtained in the same manner as in Example 19, except for using valine in place of glycine as an amino acid.

### Example 22

Example 22 was obtained in the same manner as in Example 19, except for using leucine in place of glycine as an amino acid.

### Example 23

Example 23 was obtained in the same manner as in Example 19, except for using isoleucine in place of glycine as an amino acid.

### Example 24

Example 24 was obtained in the same manner as in Example 19, except for using proline in place of glycine as an amino acid.

### Example 25

Example 25 was obtained in the same manner as in Example 19, except for using triptophan in place of glycine as an amino acid.

### Example 26

Example 26 was obtained in the same manner as in Example 19, except for using threonine in place of glycine as an amino acid.

### Example 27

Example 27 was obtained in the same manner as in Example 19, except for using serine in place of glycine as an amino acid.

### Example 28

Example 28 was obtained in the same manner as in Example 19, except for using methionine in place of glycine as an amino acid.

In Examples 19 to 28, pH was adjusted to 10.5.

Polishing conditions are as follows, and evaluation method of polishing rate is the same as above.

Polishing Conditions

Substrate to be polished: 100 mm diameter copper-plated substrate

Polishing apparatus: ECOMET 4 (manufactured by BUEHLER)

Polishing pad: IC 1400 (manufactured by Nitta Haas Incorporated)

Relative speed of polishing platen: 745 mm/sec

Polishing load surface pressure: 27 hPa, 39 hPa, 70 hPa, 140 hPa, 240 hPa

Flow rate of polishing composition: 30 ml/min

Polishing time: 60 seconds

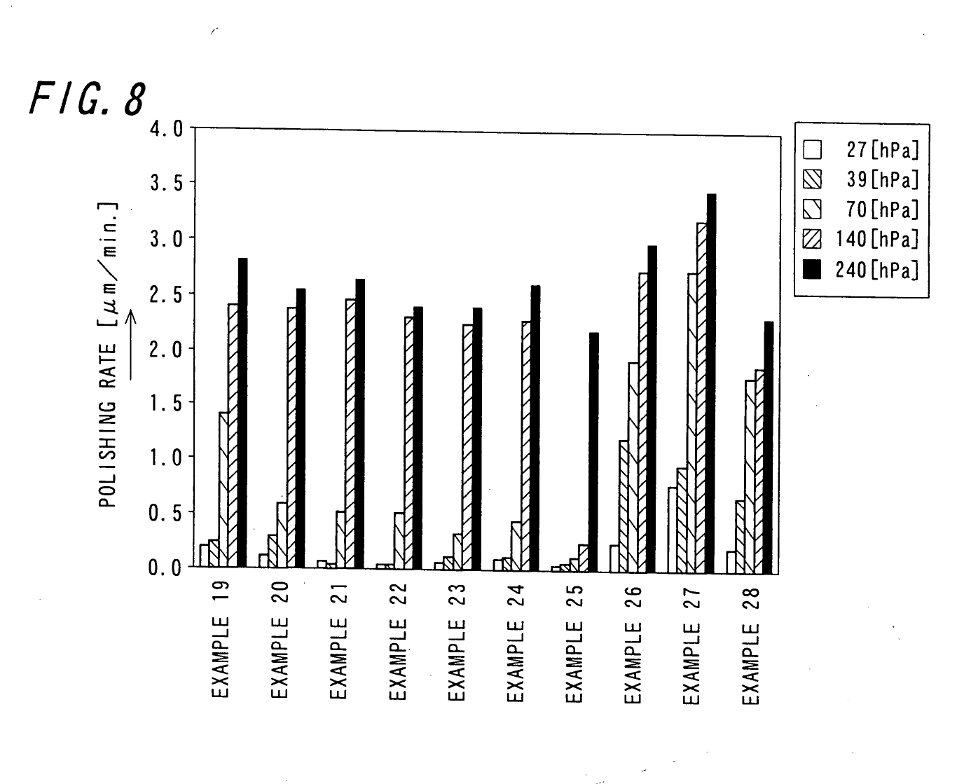

Measurement results of polishing rate under each load condition are shown in FIG. 8.

In the case of using threonine, serine and methionine, polishing rate greatly differed between the load condition of 27 hPa and the load condition of 240 hPa, and load dependency was seen. However, the tendency of increasing polishing rate with increasing load was seen.

Contrary to this, in the case of using glycine, alanine, valine, leucine, isoleucine, proline and triptophan, polishing rate can be suppressed low even under load conditions of 39 hPa, 70 hPa and the like. By this, excellent load dependency is exhibited such that polishing rate is suppressed low in a low load region and polishing rate is greatly increased in a high load region.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

### INDUSTRIAL APPLICABILITY

The invention is characterized by containing ammonia, hydrogen peroxide, an amino acid and alkyl benzene sulfonate.

By this, particularly in the case of using in a second step polishing, generation of recessing and dishing can be suppressed, and higher polishing rate can be realized.

The invention can preferably be used at a pH within a range of from 7 to 11.5. The case that pH is acidic is not preferred as described before, and where pH exceeds 11.5, polishing rate under high load condition is too low, which is not preferred.

The invention is characterized in that the amino acid is a neutral amino acid.

By this, generation of dishing can further be suppressed.

The invention is characterized in that the neutral amino acid is at least one selected from glycine, alanine, valine, leucine, isoleucine, proline and triptophan.

By using those neutral amino acids, low load region which suppresses polishing rate low can be expanded, and further excellent load dependency is exhibited.

1. A polishing composition comprising ammonia, hydrogen peroxide, an amino acid and alkyl benzene sulfonate.

2. The polishing composition of claim 1, wherein the polishing composition has a pH of 7 to 11.5.

3. The polishing composition of claim 1, wherein the amino acid is a neutral amino acid.

4. The polishing composition of claim 3, wherein the neutral amino acid is at least one selected from glycine, alanine, valine, leucine, isoleucine, proline and tryptophan.

5. The polishing composition of claim 2, wherein the amino acid is a neutral amino acid.

6. The polishing composition of claim 5, wherein the neutral amino acid is at least one selected from glycine, alanine, valine, leucine, isoleucine, proline and tryptophan.
